(19) United States
(12) Patent Application Publication
(10) Pub. No.: US 2011/0001629 A1
(43) Pub. Date: Jan. 6, 2011

(54) INTELLIGENT ELECTRONIC BLANKET

(75) Inventor: Markus Gerardus Leonardus Maria Van Doorn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/918,835

(22) PCT Filed: Feb. 23, 2009
(86) PCT No.: PCT/IB2009/050725

§ 371 Date: Aug. 23, 2010

(30) Foreign Application Priority Data
Feb. 28, 2008 (EP) 08152060.3

(51) Int. Cl. G08B 21/00

(52) U.S. Cl. 340/686.1

(57) ABSTRACT

An electronic blanket (1) comprising a sheet (2) of a foldable material, a sensor array (3), including one or several sensors (31,32,33,34), and a sensor target (4) adapted to affect said sensor array, wherein said sensor array is adapted to detect presence of said sensor target (4), said sensor array (3) and said sensor target (4) being attached to said sheet (1). The blanket also comprises circuitry (5) arranged to generate a state variable in response to detections by said sensor array (3), wherein said sensor array (3) and said sensor target (4) are arranged so that said state variable indicates when said electronic blanket has assumed a given state. As the sensor array and the sensor targets are both attached to the sheet, they provide information related to the positioning of the blanket in relation to itself.

### TECHNICAL FIELD

The present invention relates to an electronic blanket, to be used e.g. as a bed sheet, a bed cover, or a curtain.

### BACKGROUND OF THE INVENTION

Employing electronic components in blankets to provide additional functionality is well-known in the art.

U.S. Pat. No. 7,144,830 discloses a woven textile which includes electronic function and can be used, for example, in a blanket. By providing a first type of functional yarn containing sensors and/or light sources and a second type of functional yarn containing processors in the same fabric, a “smart” fabric may be woven that both senses data and processes the data sensed and that generates addressing for illuminating light sources and illuminates the addressed light sources.

As suggested in U.S. Pat. No. 7,144,830, prior art arrangements may include sensors of temperature, force, pressure, sound, a magnetic field or some other condition, and thereby detect conditions in the environment surrounding the blanket. However, such sensors have shown to be inadequate for detecting the state of the blanket itself.

### SUMMARY OF THE INVENTION

In view of the above, an object of the invention is to solve or at least reduce the problems discussed above.

According to an aspect of the invention, there is provided an electronic blanket comprising a sheet of a foldable material, a sensor array, including one or several sensors, and a sensor target adapted to affect the sensor array, wherein the sensor array is adapted to detect presence of the sensor target, the sensor array and the sensor target being attached to the sheet, and circuitry arranged to generate a state variable in response to detections by the sensor array, wherein the sensor array and the sensor target are arranged so that the state variable indicates when the electronic blanket has assumed a given state.

The present invention is based on the understanding that by locating sensor targets, specifically adapted to trigger detection by the sensor array, in the sheet itself, the circuitry can detect when the sheet has assumed a given state without any need for external devices. As the sensor array and the sensor targets are both attached to the sheet, they provide information related to the positioning of the blanket in relation to itself.

Through this arrangement the electronic blanket can detect whether it has assumed a given state enabling the electronic blanket to automatically respond when the electronic blanket has been arranged in a given position, thereby enabling enhanced safety and/or user comfort in a wide range of applications. The arrangement is not dependent on any external devices (arranged outside the blanket) to detect a given state, as both the sensor array and the sensor target is arranged in the electronic blanket.

The electronic blanket may be adapted for use in a bed, wherein the given state can indicate that the blanket is arranged in a way that allows a person to get in or out of bed. This enables the electronic blanket to automatically respond as a person is getting in or out of bed, thereby enabling functionality for assisting or monitoring this person.

At least one of the sensor(s) may be a proximity sensor arranged to generate an electromagnetic field and detect changes therein introduced by the sensor target. By utilizing magnetic fields, the detection can be triggered without the need for direct contact with the sensor target. Thus, the proximity sensor(s) and the sensor target may advantageously be arranged inside the blanket for aesthetic reasons and for protection of the sensor(s). Furthermore, utilizing a proximity sensor also allows a large area to be covered by small sensor. Also, the detection range, i.e. the range within which the sensor target can be detected, can be adjusted by changing the magnetic field.

The sensor target may comprise a plurality of target areas arranged on the electronic blanket. This enables flexibility in the design of the electronic blanket. Moreover, by utilizing a plurality of target areas, a better reliability may be achieved for some given states.

The circuitry may comprise a control unit connected to the sensor array, wherein the control unit is arranged to receive a detection signal from each sensor in the sensor array and determine whether the electronic blanket has assumed the given state based on the detection signals. This enables enhanced reliability due to more sophisticated analysis in determining the state of the electronic blanket, for example, by considering a combination of signals from the sensors. The control unit can also be used to control operation of other electronic components, such as, for example, LEDs.

According to an embodiment the electronic blanket further comprises an LED array connected to the circuitry thereby enabling the electronic blanket to, for example, light up a room. This may provide enhanced convenience by providing light that guides a user to the toilet, or contribute to a more aesthetical atmosphere by replacing a bedside lamp.

According to an embodiment the electronic blanket further comprises a network device connected to the circuitry, thereby enabling a notification to be transmitted to a remote location when the electronic blanket has assumed the given state. This enables remote monitoring of a person such as, for example, a patient in a hospital.

In many applications, such as for a bed blanket, it is advantageous to utilize a soft, pliable material such as, for example, a textile.

Other objectives, features and advantages will appear from the following detailed disclosure, from the attached dependent claims as well as from the drawings.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 is a schematic view of an electronic blanket arranged on a bed in an “unfolded” state.

FIGS. 2a and 2b are schematic views of an electronic blanket arranged on a bed in a “folded” state.

FIGS. 3a and 3b are schematic views of an electronic blanket arranged on a bed in a “folded” state.

### DETAILED DESCRIPTION OF PREFERRED EMBODIMENTS

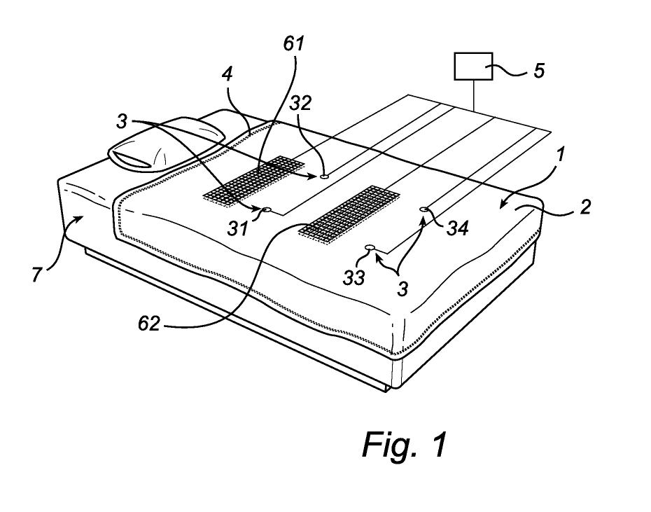

FIG. 1 illustrates an electronic blanket 1 adapted to be used as a bed blanket. The electronic blanket 1 is here formed by a textile sheet 2 provided with a sensor array 3 and a sensor target 4 adapted to affect the sensor array.

The sensor array 3 here includes four proximity sensors 31,32,33,34, each being an inductive proximity sensor capable of generating an electromagnetic field. Each proximity sensor 31,32,33,34 here has a detection range of 150 mm, and within this range the proximity sensor 31,32,33,34 is able to detect changes in the electromagnetic field introduced by the sensor target 4. The sensor array 3 could be integrated in the sheet or attached thereto. The sensor target 4 is here a metal wire.

The proximity sensors 31,32,33,34 and the sensor target 4 are positioned in a way that, if any one of the proximity sensors detects the sensor target this indicates that the electronic blanket has assumed a given state. The given state is here a state where the electronic blanket is arranged to permit a person to get in or out of bed. This state is also referred to as “folded” state. To be able to detect when this “folded” state occurs, the sensor target 4 is arranged along the edges of the electronic blanket 1, whereas the four proximity sensors 31,32,33,34 are arranged in a box pattern in the bottom half of the textile blanket 1 as illustrated in FIG. 1.

The electronic blanket 1 further comprises circuitry 5 connected to each proximity sensor 31,32,33,34, wherein the circuitry generates a state variable in response to detections by the sensors 31,32,33,34. The circuitry could be realized in a number of ways. For example, the circuitry may simply be an electronic OR-circuit, wherein the circuitry generates a state variable if any one of the sensors 31,32,33,34 detects the sensor target, or it may include a control unit such as a conventional micro processor which may process information received from the proximity sensors 31,32,33,34 to decide whether a state variable should be generated. The use of a control unit allows more complex analysis to determine whether the electronic blanket 1 has assumed a given state as information from multiple proximity sensors could be utilized. For instance, a condition that requires at least two sensors to detect the sensor target could be utilized, or there could be a requirement that presence of a sensor target is detected during a certain time period.

The sheet 2 could be a conventional textile sheet, where the electronic components are added, for example, by embroidery or by appliqué or by mechanical attachment and connected by conventional wiring.

However, it is often advantageous to utilize a textile sheet where the warp and/or the weft yarn are electrically conductive, so that the woven fabric itself functions as an electrical circuit board. That is, the electrically conductive yarn provides electrical connection between electrical components embodied in the fabric and/or to external components. This technique is known, for example, from U.S. Pat. No. 7,144,830, which is hereby incorporated by reference. Thus, sensors, connectors, LEDs, batteries and other components which are needed to operate the textile sheet may be attached to or incorporated in the fabric, for example in cavities woven therein or at an edge of the electronic blanket.

During operation, each proximity sensor 31,32,33,34 generates an electromagnetic field. As the sensor target 4 is within the detection range (here 150 mm) of any one of the proximity sensors 31,32,33,34 it will affect the electromagnetic field of that proximity sensor 31,32,33,34 which triggers the proximity sensor. In response thereto, the triggered proximity sensor 31,32,33,34 transmits an electrical signal to the circuitry 5. In a basic embodiment of the invention, where the circuitry 5 is simply an electronic OR-circuit, this would cause the circuitry 5 to generate a state variable indicating that the electronic blanket has assumed a given state. The circuitry 5 may also comprise a control unit enabling more complex analysis. For example, information from multiple proximity sensors can be utilized to analyze whether the electronic blanket has assumed a given state, and if so a state variable will be generated by the circuitry 5.

Referring to FIGS. 1 to 3 it will now be described how the electronic blanket 1 can be utilized to determine whether a person is about to get in or out of bed.

In FIG. 1 the electronic blanket is spread out on top of a bed 7. This state is referred to as “unfolded” state. The “unfolded” state does not require that the blanket is completely flat or completely stretched out. For example, a situation where an edge of the blanket is tucked beneath the mattress would still be classified as the “unfolded” state. The “unfolded” state rather suggests that the blanket is arranged in a way that a person is not able to get in or out of bed without folding away a part of the electronic blanket. The “unfolded” state illustrated in FIG. 1 can be found, for example, when a person is lying down in bed or when the bed has been made. As shown in FIG. 1, none of the proximity sensors 31,32,33,34 detects presence of the sensor target 4 in this state.

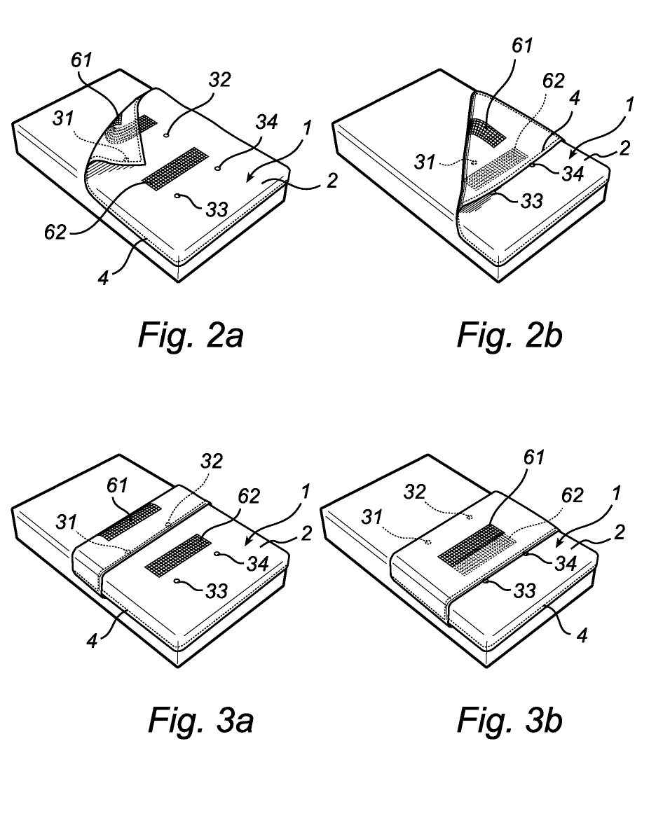

In FIGS. 2a and 2b the electronic blanket 1 has assumed a “folded” state, meaning that the blanket 1 is now arranged in a way that allows a person to get in or out of bed. Starting from the “unfolded” state depicted in FIG. 1, the blanket 1 has been rearranged by moving the upper left corner of the blanket 1 towards the lower right corner thereof, as is typically done by a person when folding away the blanket to get in or out of bed. In this situation, the sensor target 4 will be located within the detection range of at least one of the proximity sensors 31,32,33,34. Thus, at least one proximity sensor 31,32,33,34 sends an output signal to the circuitry which generates a state variable to indicate that the blanket 1 has assumed the “folded” state.

In FIG. 2a, a relatively small portion of the blanket has been folded away, wherein the upper left proximity sensor 31 detects the sensor target 4. In FIG. 2b a larger portion of the blanket has been folded away, wherein the two lower proximity sensors 33,34 detect the sensor target 4. It should be noted that the positioning of the sensor target 4 and the proximity sensors 31,32,33,34 are such that a considerable portion of the blanket must be folded away in order for any one of the proximity sensors 31,32,33,34 to detect the sensor target 4. That is, a portion of the blanket which is considered to be sufficiently large for a person to get in or out of bed has to be folded away. Thus, the “folded” state is not triggered, for example, by normal movements that typically occurs when a person is sleeping. Furthermore, the “folded” state is not triggered by tucking the blanket beneath the mattress of the bed. Naturally, the scenario described with reference to FIGS. 2a and 2b, similarly applies if the blanket is folded away in the other direction, i.e. by moving the upper right corner towards the lower left corner.

FIGS. 3a and 3b illustrates another situation where the electronic blanket 1 has been arranged in a way that allows a person to get in or out of bed. Thus, the blanket 1 is considered to have assumed a “folded” state. Starting from the “unfolded” state, the blanket 1 has been folded away by moving the upper edge of the blanket (i.e. both corners) towards the lower edge thereof, as might be done as a person is about to get in or out of bed. In this situation, the sensor target 4 will be located within the detection range of at least one of the proximity sensors 31,32,33,34. In FIG. 3a, a relatively small portion of the blanket 1 has been folded away, wherein the two upper proximity sensors 31,32 detect the sensor target. In FIG. 3b, a larger portion of the blanket has been folded away, wherein the two lower proximity sensors 33,34 detect the sensor target. Just as in the situation described with reference to FIGS. 2a and 2b, the positioning of the sensor target 4 and the proximity sensors 31,32,33,34 are such that a considerable part of the blanket 1 must be folded away in order for any one of the proximity sensors 31,32,33,34 to detect the sensor target, thereby avoiding that the “folded” state is triggered, for example, due natural movements that occur during sleep.

As exemplified by the situations in FIG. 1 to 3, the electronic blanket is able to detect when the electronic blanket has assumed a “folded” state, which allows a person to get in or out of bed, if the sensor target and the proximity sensors has been properly arranged.

It is realized that the classification “unfolded”/“folded” can be adjusted by modifying the positioning of the sensor target and the proximity sensors. The arrangement could also be adjusted by modifying the detection range of the sensors, the number of sensors or by utilizing multiple sensor target areas. Another way to adjust the classification is by modifying the control logic in the control unit.

According to an embodiment, the circuitry 5 is connected to one or more LED arrays (here LED arrays 61,62) arranged in the electronic blanket 1 as illustrated in FIG. 1 to 3. The LEDs could be attached or incorporated in the blanket by the technique described above. It is also possible to use Philips Lumalive technology for integrating LEDs in the blanket. General information on Lumalive technology can for instance be found on www.lumalive.com. A standard Lumalive display panel is based on 14×14 RGB LED mounted on a thin and flexible substrate. Each pixel contains inorganic RGB LEDs, and the display panel is covered with a splash waterproof protection cover.

The LEDs are here arranged both on the upper side and under side of the blanket to allow the LEDs to light up the room when the blanket is in a “folded” state, but also when the blanket is “unfolded” as might be desired in a wake-up application as described below. Having more than one LED array, and having LED arrays on both the upper side and the under side of the blanket, ensures that the light is not accidentally covered by the folded blanket. It is realized that FIG. 1 to 3 is just an example of one possible arrangement of LED arrays and that the number of LED arrays and their positioning might be modified as applicable. For example, the LED array 62 may be arranged closer to the bottom edge of the blanket so that it would not be covered in the folded state illustrated in FIG. 2b.

In an application where the electronic blanket 1 is arranged to determine whether the electronic blanket 1 has assumed the “folded” state which implies that a person is about to get in or out of bed, it can turn on the LED arrays 61,62. Thus, the LED arrays 61,62 are automatically switched on when the user wakes up at night and folds away the blanket 1, providing the user some light to walk safely to the toilet. The arrangement may also be used for aesthetic reasons. For example, a separate bedroom table lamp might not be needed in the room, as simply folding the electronic blanket will turn on the LED arrays.

In applications with an LED array, the circuitry 5 may include a control unit to enable control of the illumination and brightness. For instance, the individual LEDs of each LED array 61,62 could be controlled individually and/or as a group to form various illumination patterns.

According to one embodiment of the invention, the electronic blanket comprises a timer connected to the control unit enabling time based control of the functionality provided by the electronic blanket. Thus in one application, a wake up time could be set by a user using a control knob connected to the timer, wherein the electronic blanket could be used to wake people up in the morning. The timer triggers the control unit which actives the LED arrays at a time preset time. Typically, the LEDs start to glow faintly at first and gently start to glow brighter. Folding the blanket and unfolding it again could switch off the light or set the sleep timer wherein the light will dim but reappear after a fixed interval.

The electronic blanket may also be provided with a user control connected to the control unit enabling user interaction, such as setting an alarm function on/off. The user could also choose between atmosphere presets, such as, sunset experience, rain drops pattern etc.

According to an embodiment the electronic blanket comprises a network device providing wired or wireless network communication. The network device is here connected to the circuitry, enabling a notification to be transmitted to a remote location when the electronic blanket assumes the given state. Thus, in a typical application for hotel rooms, the action of folding the electronic blanket into the “folded” state could notify room service that a person has woken up and may want room service. Similarly, in, for example, hospitals or elderly care home settings this would mean that a nurse would be notified to check on a patient. This could help monitoring sleepwalking or Alzheimer patients who wander off in the middle of night.

The invention has mainly been described above with reference to a few embodiments. However, as is readily appreciated by a person skilled in the art, other embodiments than the ones disclosed above are equally possible within the scope of the invention, as defined by the appended claims.

Although the sensor has been described as an inductive proximity sensor, and the sensor target has been a metal object it is recognized that alternative sensors may be utilized. For example, a capacitive or photoelectric sensor might be suitable for a plastic target. It is also possible to utilize a contact sensor where the sensor and the sensor target are both conductors, wherein a closed circuit is formed when the sensor and the sensor target comes into contact with each other. RFID-technology is yet another alternative.

Although the embodiments and situations described have been described in the context of a single bed it is realized that the invention could also be applied for a double bed. Although, the embodiments described have utilized an “unfolded” and a “folded” state, it is recognized that the concept of the invention could be utilized to distinguish between more than two states.

The invention is not limited to electronic blankets used in a bed, and the inventive concept could be used in alternative applications for any electronic blankets, formed by textile sheets or any other kind of foldable material. An example would be intelligent curtains so that when you open or close the curtain the light in your room is turned on or off.

Although the sensor target has been described as a metal wire arranged along the edges of the blanket the sensor target may vary in shape, size and material depending on the application. For instance, the sensor target may comprise a plurality of target areas arranged on the electronic blanket.

1. An electronic blanket comprising:
a sheet of a foldable material,
a sensor array, including one or several sensors, and a sensor target adapted to affect said sensor array, wherein said sensor array is adapted to detect presence of said sensor target, said sensor array and said sensor target being attached to said sheet, and
circuitry arranged to generate a state variable in response to detections by said sensor array,
wherein said sensor array and said sensor target are arranged so that said state variable indicates when said electronic blanket has assumed a given state.

2. An electronic blanket according to claim 1, wherein said electronic blanket is adapted for use in a bed and said given state indicates that said blanket is arranged in a way that allows a person to get in or out of bed.

3. An electronic blanket according to claim 1, wherein at least one of said sensor(s) is a proximity sensor arranged to generate an electromagnetic field and detect changes therein introduced by said sensor target.

4. An electronic blanket according to claim 1, wherein said sensor target comprises a plurality of target areas arranged on said electronic blanket.

5. An electronic blanket according to claim 1, wherein said circuitry comprises a control unit connected to said sensor array, wherein said control unit is arranged to receive a detection signal from each sensor in said sensor array and determine whether said electronic blanket has assumed said given state based on said detection signals.

6. An electronic blanket according to claim 1, further comprising an LED array connected to said circuitry thereby enabling said electronic blanket to light up a room.

7. An electronic blanket according to claim 1, further comprising a network device connected to the circuitry, thereby enabling a notification to be transmitted to a remote location when the electronic blanket has assumed the given state.
